(19) United States
(12) Patent Application Publication
(10) Pub. No.: US 2023/0406745 A1
(43) Pub. Date: Dec. 21, 2023

(54) METHOD OF TREATING A COOLING CIRCUIT WATER CONTAMINATED WITH ORGANIC SUBSTANCES AND INORGANIC PARTICLES

(71) Applicant: SMS group GmbH, Düsseldorf (DE)

(72) Inventors: Angela ANTE, Dattenberg (DE); Michael BREUER, Hilchenbach (DE); Peter BRÜCHER, Siegen (DE); Alberto BREGANTE, Milan (IT)

(73) Assignee: SMS group GmbH, Düsseldorf (DE)

(21) Appl. No.: 18/249,153

(22) PCT Filed: Sep. 6, 2021
(86) PCT No.: PCT/EP2021/074450

§ 371 Date: Jul. 14, 2023

(30) Foreign Application Priority Data
Oct. 16, 2020 (DE) 10 2020 213 077.9

(51) Int. Cl. C02F 9/00; C10M 173/02; C10M 175/00

(52) U.S. Cl. CPC C02F 9/00; C10M 173/02; C10M 175/0016; C02F 2103/023; C10M 175/0066; C10M 175/005; C10M 175/0058

(57) ABSTRACT

A method of treating cooling circuit water of industrial plants (2) contaminated with organic substances and inorganic particles, comprises the following steps: a) separating the organic substances and inorganic particles from the cooling circuit water to obtain precleaned cooling circuit water; b) cooling the precleaned cooling circuit water by an open cooling tower (11) to obtain cooled precleaned cooling circuit water; c) desalinating at least a partial volume flow of the cooled precleaned cooling circuit water by an desalination plant (14) to obtain cleaned cooling circuit water; and d) adding bacteria capable of degrading organic substances present in the cooling circuit water. The bacteria are added to the cooling circuit water before the separation in accordance with step a), before the cooling in accordance with step b) and/or before the desalination in accordance with step c), to form a biological cleaning stage.

### CROSS-REFERENCE TO RELATED APPLICATION

This application is a national stage application, filed under 35 U.S.C. § 371, of International Patent Application No. PCT/EP2021/074450, filed on 6 Sep. 2021, which claims the benefit of German Patent Application No. 10 2020 213 077.9, filed 16 Oct. 2020.

### BACKGROUND

The present disclosure relates to a method and a plant for treating cooling circuit water of industrial plants, in particular of a hot rolling mill, which is contaminated with organic substances and inorganic particles.

In industrial plants, in particular in a hot rolling mill, large quantities of water are needed to cool the process line, and their salt content is concentrated during the cooling process. Therefore, a partial flow, the so-called blowdown water, is diverted and in most cases discharged directly or fed into the public sewer system.

Due to increasing water scarcity along with rising costs in the field of water treatment, efforts are being made to reduce the amount of blowdown water in order to achieve the greatest possible savings in fresh water. For this purpose, desalination plants, in which the blowdown water is purified by means of reverse osmosis, are used. This shows that although water of high quality can be recovered with high yields, the membranes used have a greatly reduced service life, such that the operational stability of the desalination plants is at risk.

### SUMMARY

The present disclosure is based on the object of providing a method and a plant that overcome the disadvantages of the prior art. In particular, the present disclosure is based on the object of providing a method and a plant that improves the service life of membranes used in the desalination plant.

The object is achieved in accordance with the method and plant as disclosed and claimed.

Advantageous embodiments are indicated in the dependent formulated claims. The features listed individually in the dependent formulated claims can be combined with one another in a technologically useful manner and may define further embodiments of the invention. In addition, the features indicated in the claims are further specified and explained in the description, wherein further preferred embodiments of the invention are illustrated.

A first aspect relates to a method of treating cooling circuit water of industrial plants, in particular of a hot rolling mill, which is contaminated with organic substances and inorganic particles. Thereby, the method comprises the steps:
a) separating the organic substances and inorganic particles from the cooling circuit water so as to obtain precleaned cooling circuit water,
b) cooling the precleaned cooling circuit water by means of an open cooling tower so as to obtain cooled precleaned cooling circuit water,
c) desalinating at least a partial volume flow of the cooled precleaned cooling circuit water by means of an at least one-stage desalination plant so as to obtain cleaned cooling circuit water, and
d) adding bacteria capable of degrading organic substances present in the cooling circuit water, wherein the bacteria are added to the cooling circuit water before the separation in accordance with step a), before the cooling in accordance with step b) and/or before the desalination in accordance with step c), so as to form a biological cleaning stage.

Surprisingly, it has been shown that the addition of the bacteria to the cooling circuit water can significantly increase the service life of the membranes used in the desalination plant. By using the bacteria, the service life of the membranes could advantageously be increased by at least 600%, particularly preferably by at least 900%, and most preferably by at least 1200% compared to a conventional pretreatment of blowdown water.

For example, a granulate available from the applicant under the product name “Oilco-Bacteria” can be used as the bacterial culture.

The present invention is based on the essential finding that the organic substances and inorganic particles contained in the cooling circuit water are not completely removed by means of the conventional separation in accordance with step a) and the fraction remaining in the cooled precleaned cooling circuit water (blowdown water), which is fed at least as a partial volume flow to the at least one-stage desalination plant, blocks the membranes to such an extent that the greatly reduced service lives observed occur.

The organic substances, in particular oils and greases, combine with the inorganic-containing particles solid in the cooling circuit water, in particular scale, which consists mainly of iron (II,III) oxide, to form highly adhesive fine agglomerates that irreversibly block the membranes. Thereby, the scale, which has a particle size of 500 nm to 3000 nm in the blowdown water, is coated by the oils and greases. The bacteria added to the cooling circuit form biocoenoses in one or more regions of the cooling circuit, in which the bacteria settle and break down or metabolize the organic substances, in particular the oils and greases, which are responsible for the adhesive property of the fine agglomerates. Only the bare scale particles then remain in the cooling circuit water, which can no longer block the membranes due to their lack of adhesive properties.

A biocenosis within the meaning of the present disclosure is a community of organisms in a delimited habitat (biotope), wherein the biocenosis and the biotope together form an ecosystem.

The bacteria are added to the cooling circuit water before the separation in accordance with step a), before the cooling in accordance with step b) and/or before the desalination in accordance with step c). The bacteria may thus be added to the water of a cooling circuit locally, or preferably in a manner distributed over the entire cooling circuit, in order to form the biological cleaning stage. When the bacteria are added throughout the entire cooling circuit, the advantage is that any aggregates in the cooling circuit remain largely free of the sticky deposits that would normally have to be removed from the entire cooling circuit at regular intervals and disposed of separately. The removal of such deposits, which include the organic substances along with the inorganic particles, can thus be saved, which has a beneficial effect on the ongoing operating costs of the plant. In this embodiment, the addition of biocide to the cooling circuit water is excluded, since the biocide would then destroy the biocoenosis formed by the bacteria. In the case of local addition of the bacteria, in particular into the partial volume flow of the cooled precleaned cooling circuit water to be desalinated, the addition of biocide into the remaining main volume flow can be advantageous. For this purpose, biocides that have only a low, or particularly preferably no, remanence effect are preferably used.

Regardless of the particular embodiment, the main volume flow of the cooled precleaned cooling circuit water, which is conveyed in the cooling circuit section from the open cooling tower via a main line to the industrial plant, amounts to preferably 1000 to 30000 m³ per hour. The partial volume flow of the cooled precleaned cooling circuit water, which is fed via a bypass line from the main volume flow of the at least one-stage desalination plant, amounts to preferably 25 to 500 m³ per hour, more preferably 50 to 200 m³ per hour.

In the same manner, the disclosure provides a plant for treating cooling circuit water of industrial plants, in particular of a hot rolling mill, contaminated with organic substances and inorganic particles. The plant comprises:
a) a separation device for separating the organic substances and the inorganic particles from the cooling circuit water in order to obtain precleaned cooling circuit water,
b) an open cooling tower through which the precleaned cooling circuit water can be cooled,
c) an at least one-stage desalination plant, by means of which at least a partial volume flow of the cooled precleaned cooling circuit water can be desalinated, in order to obtain cleaned cooling circuit water, and
d) a dosing device for adding bacteria capable of degrading the organic substances present in the cooling circuit water, wherein the dosing device is arranged upstream of the separation device, upstream of the cooling tower and/or upstream of the desalination plant, so as to form a biological cleaning stage.

In an advantageous embodiment, a residual amount of the organic substances and/or inorganic particles contained in the partial volume flow of the cooled precleaned cooling circuit water (blowdown water) is separated before step c). If the concentration of the released solid inorganic particles is too high for subsequent desalination, it can advantageously be separated first. Preferably, the separation in accordance with step b1) of the released solid inorganic particles is carried out gravimetrically. Due to the ferromagnetic properties of the inorganic particles, it is particularly preferred that the separation in accordance with step b1) is carried out by means of magnetic separation. By separating the inorganic particles beforehand, the desalination membranes are protected and can be used longer, which has a beneficial effect on operating costs.

In a further preferred embodiment, it is provided that nutrients are added to the cooling circuit water prior to step a) before the cooling in accordance with step b) and/or before the desalination in accordance with step c), which nutrients promote the growth of the added bacteria. The added nutrients promote the formation of the biocenosis by the bacteria and further favor its long-term existence. Preferably, it is thereby provided that the ratio of added bacteria to added nutrients is reduced over time. In this connection, it is particularly preferred that the bacteria are added as a function of the formation of the biocenosis. For the initial formation of biocenosis in a cooling circuit, a higher concentration of bacteria is beneficial. Thus, a particularly preferred mixture of added bacteria and added nutrients contains 1% by weight of bacteria and 99% by weight of nutrients. On the other hand, to maintain an already formed biocenosis, an increased nutrient concentration is beneficial. Thus, the concentration of added bacteria decreases below 1% by weight with increasing application time, while simultaneously adding over 99% by weight of nutrients.

The bacteria are pure cultures of species that specifically degrade oil and grease. Some are to be able to grow under anaerobic environmental conditions in order to exist in a settling basin and deeper layers of a clarifying basin; other species must be able to live aerobically, in order to be able to remove oils and greases in the cooling tower and on the surface of the clarifying basin as well.

The nutrients are primarily nitrogen and phosphorus, although sulfur, potassium, magnesium and/or sodium are also used. A micronutrient blend can also be a component of the concentrate. This comprises a mixture of metals such as copper, nickel, cobalt, manganese, molybdenum, tungsten, zinc and/or tungsten, possibly supplemented by boron, silicon and/or selenium and possibly other elements and/or amino acids. The iron usually contained in bacterial media is not necessary, as it is present in the cooling circuit in sufficient concentration; this applies in the same way to calcium.

In an additional advantageous embodiment, the bacteria and/or the nutrients are provided in the form of a granulate and are added to the water of a cooling circuit within a cooling circuit in the form of an aqueous solution. The granules contain the bacteria and/or the nutrients in a concentrated form, such that the storage requirement is reduced. Conveniently, the granules are dissolved in water. For this purpose, the water is advantageously initially heated to a temperature comparable to that of the water of the cooling circuit. Then, the granules are added and the solution is prepared. After a maturing time of 3 to 6 h, the solution is added to the water of the cooling circuit. This has been shown to significantly improve the dissemination of bacteria and/or nutrients in the cooling loop. In this connection, it is further preferably provided that the bacteria in the granules are lyophilized bacteria. Lyophilized bacteria (freeze-dried bacteria) have a significantly higher shelf life, such that the granules can be stored for longer periods.

In a further preferred embodiment, the cooling circuit water contaminated with the organic substances and the inorganic particles in accordance with step a) is passed through a settling basin, a clarifying basin and/or a filtration purification device. In this connection, it is particularly preferred that with the embodiment variant according to which the bacteria are added to the cooling circuit water only before the separation in accordance with step a) and/or before the cooling in accordance with step b), they are added to the cooling circuit water with different environmental requirements, in particular anaerobic, anoxic and/or aerobic. The bacteria spread according to the respective environment and form a biocenosis in the respective parts of the plant.

In a particularly preferred embodiment, the cooling circuit water cleaned in accordance with step c), i.e. the desalinated blowdown water, is fed to the industrial plant, if necessary after conditioning. This results in a high savings of water. Another advantage is that the industrial plant can also be operated in regions that have no receiving water in the immediate vicinity.

The term “conditioning of the desalinated blowdown water” within the meaning of the present disclosure means an addition of corrosion inhibitors and, if necessary, of alkalis for pH regulation.

Preferably, desalination after step c) is carried out by means of reverse osmosis, by means of capacitive deionization or by means of thin film evaporation. The desalination plant is designed to be at least one-stage. Preferably, however, the desalination plant is designed to have one to two stages or four stages.

In accordance with a particularly preferred embodiment, the bacteria are added only to the partial volume flow of the cooled precleaned cooling circuit water. For this purpose, the plant has a dosing device arranged in a bypass line fluidically connecting the cooling tower with the at least one-stage desalination plant. In this connection, it is particularly preferred that the partial volume flow is passed over a reactor used to form the biological cleaning stage before the desalination in accordance with step c).

The reactor is preferably designed as a biological fixed-bed reactor, trickling filter or trickle bed reactor. The reaction chamber of the respective reactor is filled with a suitable carrier material and can be flowed through. Fixed-bed reactors have a very high space conversion rate and also combine biological metabolic activity with the filtration effect of the carrier material as a depth filter, such that, in this case, the oils and greases are first retained inside the bed and then metabolized by the bacteria. In other words, the bacteria form a biofilm on the surface of the support material, which at least partially protects the bacteria from biocides and other influences that damage the bacteria.

The invention is not limited to plants of the hot rolling mill described in more detail here, but can in principle also be applied in other branches of industry, such as plants of the food industry, refineries, the chemical industry along with the pharmaceutical industry.

The invention and the technical environment are explained in more detail below with reference to the figures. It should be noted that the invention is not limited by the exemplary embodiments shown, and thus is intended solely for the purpose of understanding the invention. In particular, unless explicitly shown otherwise, it is also possible to extract partial aspects of the facts explained in the figures and combine them with other components and findings from the present description and/or figures. In particular, it should be noted that the figures and in particular the size relationships shown are only schematic. Identical reference signs designate identical objects, such that explanations from other figures may be used as a supplement if necessary. The following is shown:

### BRIEF DESCRIPTION OF THE DRAWINGS

FIG. 1 is a schematic illustration of a plant for treating cooling circuit water contaminated with organic substances and inorganic particles in accordance with a first embodiment,

FIG. 2 is a schematic illustration of a plant for treating cooling circuit water contaminated with organic substances and inorganic particles in accordance with a second embodiment,

FIG. 3 is a schematic illustration of a plant for treating cooling circuit water contaminated with organic substances and inorganic particles in accordance with a third embodiment, and

FIG. 4 is a schematic illustration of a plant for treating cooling circuit water contaminated with organic substances and inorganic particles in accordance with a fourth embodiment.

### DETAILED DESCRIPTION

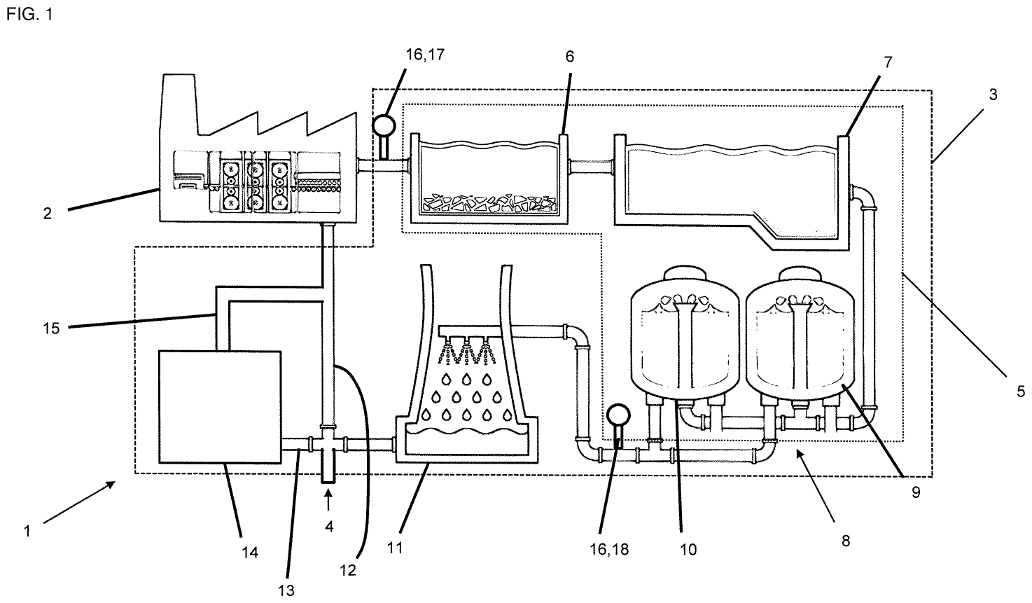

In the embodiment shown here, the plant 1 shown in FIG. 1 comprises a hot rolling mill 2 that is adjoined by a cooling circuit 3. The cooling circuit 3 comprises a plurality of aggregates, each of which is fluidically interconnected and will be explained in more detail below.

As shown, the hot rolling mill 2 is initially coupled to the cooling circuit 3, such that cooling circuit water that has been consumed in the hot rolling mill 2 and contaminated with organic substances, such as oils and greases, along with inorganic particles, such as scale in particular, is treated by the aggregates arranged in the cooling circuit 3 to such an extent that it can be fed directly back to the hot rolling mill 2. If the quantity of water of the cooling circuit should fall below a specific volume, additional fresh water can be added to the cooling circuit 3 via a fresh water inlet 4. If necessary, biocides, hardness stabilizers, flocculants and precipitating agents and other additives can be added to this.

The plant 1 shown in FIG. 1 initially comprises a separation device 5 for separating the organic substances and the inorganic particles from the water of the cooling circuit of the hot rolling mill 2, such that precleaned water of the cooling circuit is obtained. As can be seen from FIG. 1, the separation device 5 comprises a plurality of components connected in series. In the present embodiment shown, the separation device 5 comprises a settling basin 6 for separating a coarse fraction of a mixture of organic substances and inorganic particles, a clarifying basin 7 for separating an average size of the mixture of organic substances and inorganic particles, along with a filtration device 8, which generally comprises a plurality of filtration units. It should be noted that, in the present embodiment, only two filtration units 9, 10 of the plurality of filtration units of the filtration device 8 connected in parallel are shown as examples. In both filtration units 9, 10, a fine fraction of the mixture of organic substances and inorganic particles is separated. Each of the two filtration units 9, 10 of the filtration device 8 is in the form of a gravel filter in the present embodiment.

Furthermore, the plant 1 shown in FIG. 1 comprises an open cooling tower 11, via which the precleaned water of the cooling circuit can be cooled. In the cooling tower 11, the precleaned cooling circuit water is sprayed such that an aerosol is formed, which then condenses and cools down in the process. The cooled precleaned cooling circuit water then obtained (so-called “blowdown water”) is divided into a main volume flow and a partial volume flow. The main volume flow is fed to the hot rolling mill 2 via a main line 12. The partial volume flow is fed via a bypass line 13 to an at least one-stage desalination plant 14 and desalinated in order to obtain cleaned cooling circuit water, which is then fed to the hot rolling mill 2 via a return line 15. This results in a high savings of water. Another advantage is that the plant 1 can also be operated in regions that have little groundwater or river water in the immediate vicinity.

Desalination is preferably carried out according to the principle of reverse osmosis, capacitive deionization or thin film evaporation.

Within the cooling circuit 3, the plant 1 further comprises a dosing device 16 for adding bacteria that are suitable for degrading the organic substances present in the water of the cooling circuit. In the present case, the bacteria are formed as lyophilized bacteria. The dosing device 16 can be arranged upstream of the separation device 5, upstream of the cooling tower 11 and/or upstream of the desalination plant 14.

Alternatively, the dosing device 16 can also be arranged within the separation device 5 upstream of the settling basin 6, upstream of the clarifying basin 7 and/or upstream of the filtration device 8 (not shown).

In the embodiment shown here (FIG. 1), the plant 1 comprises a first dosing device 17 arranged upstream of the separation device 5 and a second dosing device 18 arranged upstream of the cooling tower 11, via which the bacteria are added to the cooling circuit 3.

The addition of the bacteria to the cooling circuit water significantly increases the service life of the membranes (not shown) used in the desalination plant 14. This is due to the fact that the organic substances, in particular oils and greases, and inorganic particles, in particular scale, which consists predominantly of iron (II,III) oxide, contained in the cooling circuit water form highly adhesive fine agglomerates, which cannot be completely removed by means of the separation device 5. The bacteria added to the cooling circuit 3 break down or metabolize the organic substances, in particular the oils and greases, which are responsible for the adhesive property of the fine agglomerates, such that the scale particles then bare in the cooling circuit water can no longer block the membranes due to the lack of adhesive property. When the bacteria are added throughout the entire cooling circuit 3, as shown in the present case, there is also the advantage that any aggregates of the cooling circuit 3 remain largely free of the sticky deposits that would normally have to be removed from the entire cooling circuit 3 at regular intervals and disposed of separately. The removal of such deposits, which include the organic substances along with the inorganic particles, can thus be additionally saved, which has a beneficial effect on the ongoing operating costs of the plant 1. In such embodiment, a biocide addition to the cooling circuit water is excluded, since the biocide would then destroy the biocoenosis formed by the bacteria in the settling basin 6, in the clarifying basin 7, in the filtration device 8, in the cooling tower 11 as well as in the respective lines.

Nutrients that promote the growth of the added bacteria are also added to the cooling circuit 3 via the two dosing devices 17, 18. The added nutrients promote the formation of a biocenosis by the bacteria and further favor their long-term existence. Preferably, it is thereby provided that the ratio of added bacteria to added nutrients is reduced over time. In this connection, it is particularly preferred that the bacteria are added as a function of the formation of a biocenosis. For the initial formation of a biocenosis in the cooling circuit 3, a higher concentration of bacteria is beneficial. A particularly preferred mixture of added bacteria and added nutrients contains 1% by weight of bacteria and 99% by weight of nutrients. On the other hand, to maintain an already formed biocenosis, an increased nutrient concentration is beneficial. Thus, the concentration of added bacteria decreases below 1% by weight with increasing application time, while simultaneously adding over 99% by weight of nutrients. The bacteria and the nutrients are provided in the form of a granulate and added to the cooling circuit water within a cooling circuit 3 in the form of an aqueous solution via the two dosing devices 17, 18.

The bacteria added to the water of the cooling circuit have different environmental requirements. Thus, the settling basin 6 is operated anaerobically, the clarifying basin 7 is operated anaerobically or aerobically, the filtration device 8 is operated anoxically and aerobically and the cooling tower 11 is operated aerobically.

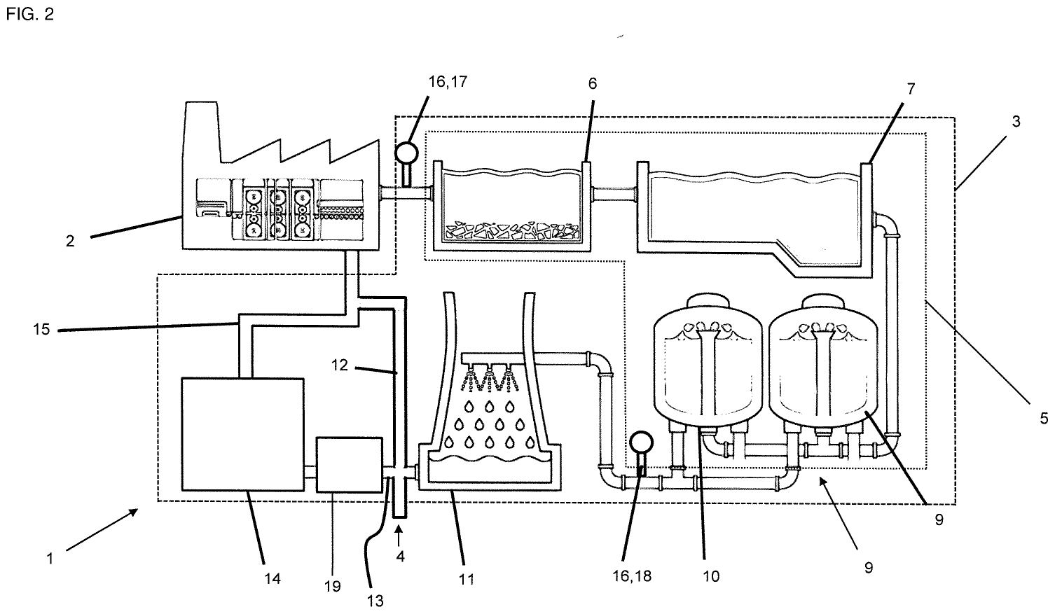

FIG. 2 shows a second embodiment of the plant 1. In contrast to FIG. 1, the plant 1 comprises a second separation device 19, which is arranged between the cooling tower 11 along with the desalination plant 14 in the bypass line 13. If the concentration of the released solid scale particles in the blowdown water is too high for subsequent desalination, they can advantageously be separated initially by means of the second separation device 19. Since the scale particles have ferromagnetic properties, the separation can be carried out by magnetic separation in addition to the usual sedimentation. By separating the scale particles beforehand, the desalination membranes are protected and can be used longer, which has a beneficial effect on operating costs.

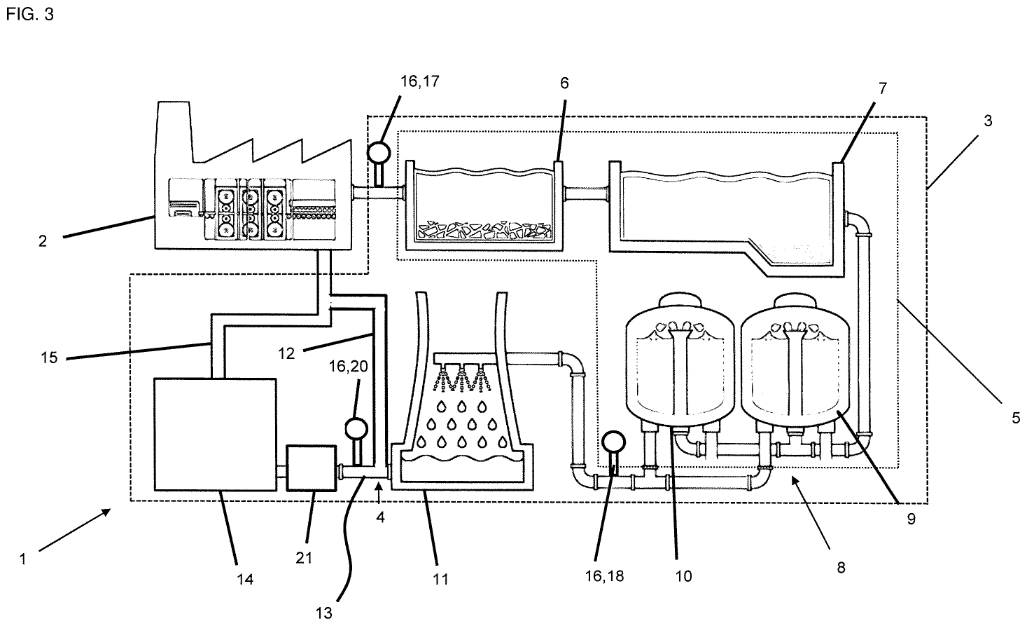

FIG. 3 shows a third embodiment of the plant 1. In contrast to the embodiment shown in FIG. 1, the bacteria are added locally to the cooling circuit water via a third dosing device 20. As shown, the bacteria in accordance with the present embodiment are only added to the partial volume flow of the blowdown water in order to dissolve the highly adhesive fine agglomerates formed from the organic substances, in particular oils and greases, and inorganic particles, in particular scale, which consists predominantly of iron (KIM oxide, for the downstream desalination. For this purpose, the plant 1 comprises a reactor 21 located downstream of the third dosing device 20, in which the biocoenosis is formed. The reactor 21 in the present embodiment is a biological fixed-bed reactor.

Since the cooling circuit formed upstream of the third dosing device 20 is thus not subject to biological purification, biocides and other additives are added via the two dosing devices 17, 18 in the embodiment shown here. Thereby, the biocides are added to the cooling circuit at intervals. In order to avoid inhibition of the biocenosis in the reactor 21, the bypass line 13 and the return line 15 are advantageously blocked via a shut-off valve (not shown) until the concentration peak has distributed in the system after approximately 3 hours and has reached a stable value.

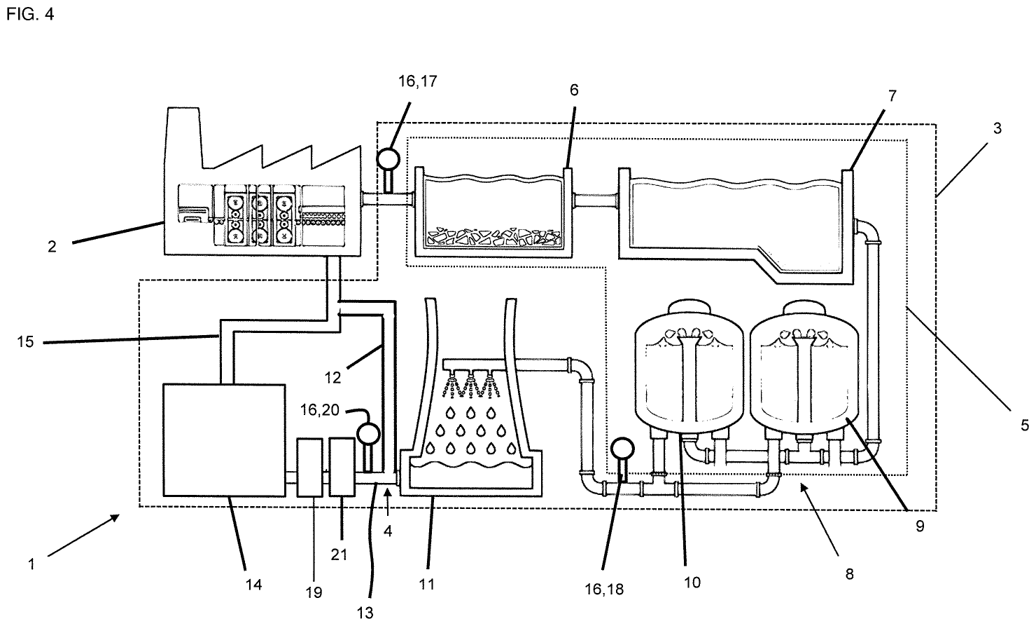

Finally, FIG. 4 shows a fourth embodiment of the plant 1 which, in contrast to the previous embodiment (FIG. 3), comprises a second separation device 19, analogous to the embodiment shown in FIG. 2, for removing the inorganic scale constituents, which is arranged in the bypass line 13 downstream of the reactor 21 and serves to relieve the desalination stages.

### LIST OF REFERENCE SIGNS

1 Plant
2 Industrial plant/hot rolling mill
3 Cooling circuit
4 Fresh water inlet
5 Separation device
6 Settling basin
7 Clarifying basin
8 Filtration device
9 Filtration unit
10 Filtration unit
11 Cooling tower
12 Main line
13 Bypass line
14 Desalination plant
15 Return line
16 Dosing device
17 First dosing device
18 Second dosing device
19 Second separation device
20 Third dosing device
21 Reactor

1.-14. (canceled)

15. A method of treating cooling circuit water of industrial plants (2), in particular of a hot rolling mill (2), contaminated with organic substances and inorganic particles, comprising the following steps:
a) separating the organic substances and the inorganic particles from the cooling circuit water so as to obtain a precleaned cooling circuit water;
b) cooling the precleaned cooling circuit water by an open cooling tower (11) so as to obtain a cooled precleaned cooling circuit water;
c) desalinating at least a partial volume flow of the cooled precleaned cooling circuit water by an at least one-stage desalination plant (14) so as to obtain a cleaned cooling circuit water; and
d) adding bacteria capable of degrading organic substances present in the cooling circuit water, wherein the bacteria are added to the cooling circuit water before the separation in accordance with step a), before the cooling in accordance with step b) and/or before the desalination in accordance with step c), so as to form a biological cleaning stage.

16. The method according to claim 15, further comprising a step b1):
separating, prior to step c), a residual amount of the organic substances and/or the inorganic particles contained in the partial volume flow of the cooled precleaned cooling circuit water.

17. The method according to claim 16, wherein separating in accordance with step b1) is carried out gravimetrically.

18. The method according to claim 16, wherein the inorganic particles are ferromagnetic, and wherein separating in accordance with step b1) is carried out by magnetic separation.

19. The method according to claim 15,
wherein nutrients that promote growth of the added bacteria are added to the cooling circuit water
before the separation in accordance with step a),
before the cooling in accordance with step b), and/or
before the desalination in accordance with step c), and
wherein a ratio of added bacteria to added nutrients is reduced over time.

20. The method according to claim 19,
wherein the bacteria and/or the nutrients are provided in the form of a granulate and are added to the water of a cooling circuit in the form of an aqueous solution, and
wherein the bacteria in the granulate are lyophilized bacteria.

21. The method according to claim 15,
wherein the cooling circuit water contaminated with the organic substances and the inorganic particles in accordance with step a) is passed through a settling basin (6), a clarifying basin (7) and/or a filtration purification device (8).

22. The method according to claim 15,
wherein the cooling circuit water cleaned in accordance with step c) is fed to the industrial plant (2), if necessary after conditioning.

23. The method according to claim 15,
wherein the desalination in accordance with step c) is carried out by reverse osmosis, by capacitive deionization or by thin film evaporation.

24. The method according to claim 15,
wherein the bacteria are added only to the partial volume flow of the cooled precleaned cooling circuit water.

25. The method according to claim 24,
wherein the partial volume flow is passed over a reactor (21) used to form the biological cleaning stage before the desalination in accordance with step c).

26. A plant (1) for treating cooling circuit water of industrial plants (2), in particular of a hot rolling mill (2), contaminated with organic substances and inorganic particles, comprising:
a) a separation device (5) for separating the organic substances and the inorganic particles from the cooling circuit water in order to obtain precleaned cooling circuit water;
b) an open cooling tower (11) through which the precleaned cooling circuit water can be cooled;
c) an at least one-stage desalination plant (14), by means of which at least a partial volume flow of the cooled precleaned cooling circuit water can be desalinated, in order to obtain cleaned cooling circuit water; and
d) a dosing device (16, 17, 18, 20) for adding bacteria capable of degrading the organic substances present in the cooling circuit water, wherein the dosing device (16, 17, 18, 20) is arranged upstream of the separation device (5), upstream of the cooling tower (11) and/or upstream of the desalination plant (14), so as to obtain a biological cleaning stage.

27. The plant (1) according to claim 26, wherein the dosing device (16, 20) is arranged in a bypass line (13) connecting the cooling tower (11) with the at least one-stage desalination plant (14).

28. The plant (1) according to claim 27, further comprising a reactor (21) arranged in the bypass line (13) and upstream of the at least one-stage desalination plant (14) and provided for forming the biological cleaning stage.
